(19) United States
(12) Patent Application Publication
(10) Pub. No.: US 2004/0185695 A1
(43) Pub. Date: Sep. 23, 2004

(54) Card slot unit for portable digital equipment

(75) Inventors: Shinnichi Takezawa, Tokyo (JP); Tomohide Chida, Hachioji-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/765,872

(22) Filed: Jan. 29, 2004

(30) Foreign Application Priority Data
Jan. 31, 2003 (JP) 2003-023872

(51) Int. Cl. H01R 13/62

(52) U.S. Cl. 439/159

(57) ABSTRACT

A card slot unit in which is detachably attached a card module is disclosed. The card slot unit has a connector and a reversal connector, and has an insulator which prevents a short circuit between the respective connectors. This insulator is configured to move to the outer side when the card module is attached inside the slot unit.

### CROSS-REFERENCE TO RELATED APPLICATIONS

This application is based upon and claims the benefit of priority from the prior Japanese Patent Application No. 2003-023872, filed Jan. 31, 2003, the entire contents of which are incorporated herein by reference.

### BACKGROUND OF THE INVENTION

1. Field of the Invention

The present invention relates to a card slot unit generally used in portable digital equipment, and more particularly to an internal structure of a card slot.

2. Description of the Related Art

In recent years, as portable digital equipment such as personal computers and personal digital assistants (PDAs), those which can use a card module (including a so-called IC card) such as a memory card or a wireless communication card are becoming common.

As a card module, a circuit module such as a memory or an integrated circuit is mounted in a card-like case. Further, a plurality of card terminals connected to the circuit module are mounted on a surface of the case usually by using a printed circuit structure.

On the other hand, a card slot used to mount the card module is provided on a main body of a digital equipment. The card slot is a case to/from which the card module can be attached/detached, and has connectors which are brought into contact with and electrically connected with each card terminal of the card module. The main body of the digital equipment has a card interface circuit connected to the connectors of the card slot, and is electrically brought into contact with the attached card module.

Meanwhile, usually, the card terminals are mounted on only one plane of a front surface or a back surface of the card module. Therefore, when a user accidentally attaches the card to the card slot with the sides reversed (so-called reverse insertion), there occurs a status that the card terminals of the card module and the connectors of the card slot are not connected to each other.

As a prior art which can solve such a problem, there has been proposed a slot unit which can be normally used even if the memory card is attached in the reverse insertion state (see, e.g., Japanese patent application laid-open No. 2002-56909).

The slot unit of the prior art has connectors (slot connectors) which are opposed to each of the both sides of the memory card, and is constituted in such a manner that the card terminals and the slot connectors can be normally connected to each other even if the memory card is attached with either of the sides turned up. Therefore, even if the so-called reverse insertion state mentioned above occurs, the memory card can be caused to normally function.

In such a slot unit of the prior art, however, when the memory card is not attached, the opposed respective slot connectors are connected to each other. A malfunction may possibly be generated in a circuit operation in the card interface circuit of the digital equipment when the respective slot connectors of the slot unit are connected to each other.

### BRIEF SUMMARY OF THE INVENTION

In accordance with one embodiment of the present invention, there is provided a card slot unit including connector members with a reversible connector and an insulator for preventing a short circuit between the connector members.

The card slot unit comprises: first and second slot connectors which are provided on respective planes of an internal space in such a manner that they are in contact with and electrically connected with card terminals mounted on one plane of a card module in the internal space which detachably accommodates the card module therein; and an insulating member which is positioned between the first and second slot connectors when the card module is not attached to prevent a contact between the first and second slot connectors.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view showing a basic structure of a card slot concerning a first embodiment of the present invention;

FIG. 2 is a cross-sectional view showing a structure of a reversible connector in the structure of the same card slot;

FIG. 3 is a cross-sectional view showing a structure of the card slot concerning the first embodiment;

FIGS. 4 and 5 are cross-sectional views showing a structure of a card slot concerning a second embodiment;

FIG. 6 is a view showing an exterior appearance of a card slot concerning each embodiment;

FIGS. 7A and 7B are views showing the exterior appearance of the card module concerning each embodiment;

FIGS. 8A and 8B are views showing an exterior appearance of a digital equipment concerning each embodiment; and

FIG. 9 is a perspective view showing the structure of the card slot concerning the first embodiment.

### DETAILED DESCRIPTION OF THE INVENTION

Embodiments according to the present invention will now be described hereinafter with reference to the accompanying drawings.

### FIRST EMBODIMENT

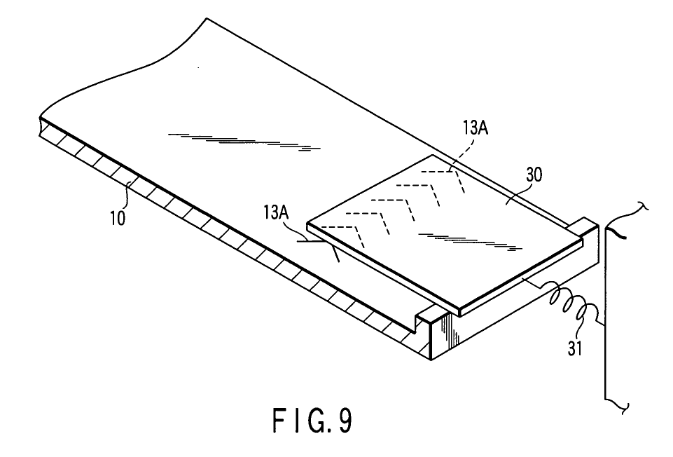

FIGS. 3 and 9 are views showing a structure of a card slot according to a first embodiment. FIG. 3 shows a structure having an insulator 30 which prevents a short circuit between connectors.

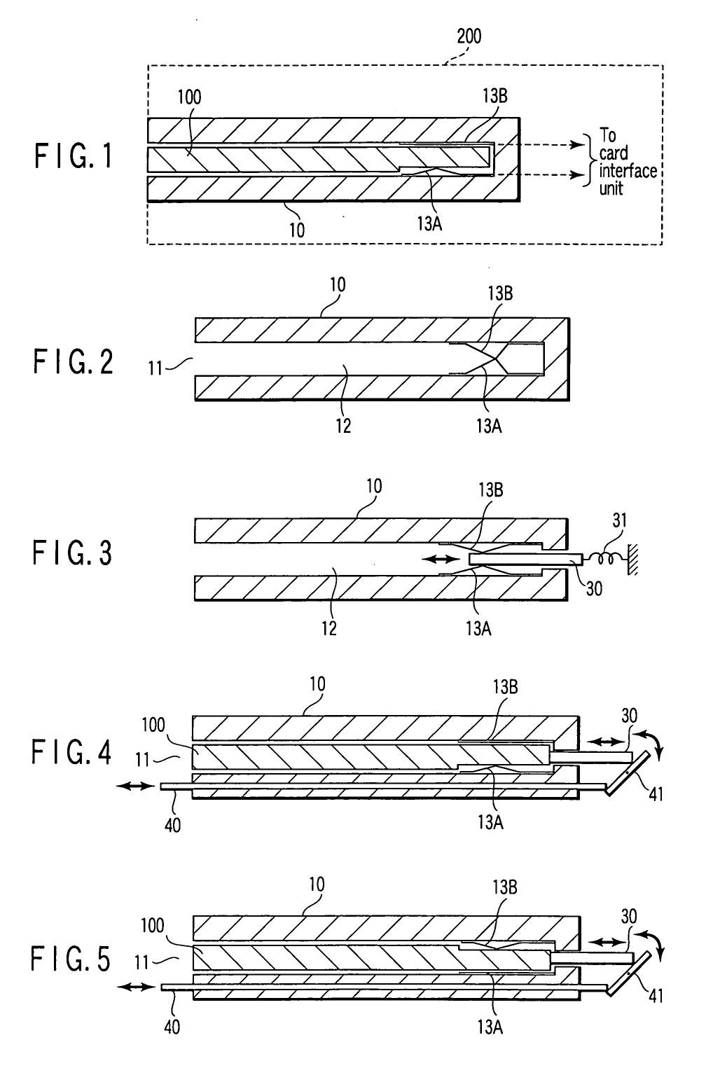

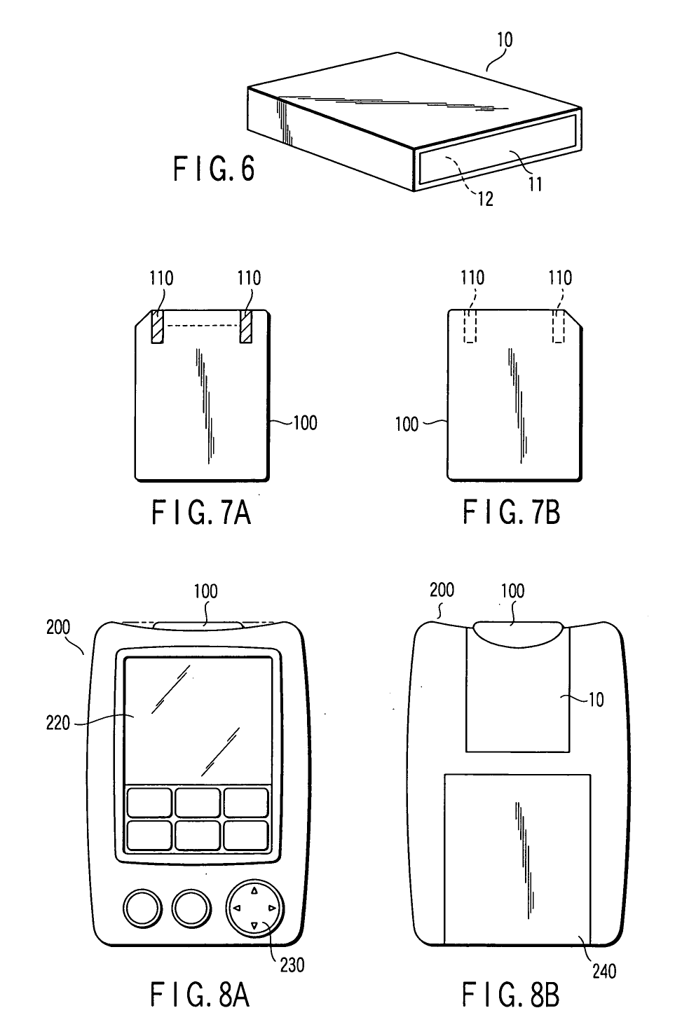

Here, a structure of the card slot from which the insulator 30 is eliminated will be described with reference to FIGS. 1, 2 and 6.

A main body 10 of the card slot has an insertion opening 11 from which a card module 100 (which will be simply referred to as a card hereinafter) such as a memory card is inserted and an internal space 12 as shown in FIGS. 1, 2 and 6. As shown in FIG. 2, a plurality of slot connectors 13A and 13B consisting of leaf spring members (metallic elastic members) are provided in the internal space 12.

Here, as shown in FIG. 1, when the card 100 is attached in the internal space 12 of the card slot 10, it is assumed that a direction in which a surface of the card 100 having terminals (which will be notated as card terminals) mounted thereon is set relatively downward is a normal direction.

When the card 100 is attached in this normal direction, the plurality of connectors 13A provided in the slot come into contact with the plurality of card terminals on the card 100. The plurality of connectors 13B arranged so as to fact these connectors 13A will be referred to as reversible connectors for the sake of convenience.

That is, as shown in FIG. 1, when the card 100 is attached in the normal direction, the reversible connectors 13B are in contact with a back side of the card 100 (plane on which the card terminals are not mounted).

Further, the card slot 10 is incorporated in digital equipment 200 such as a PDA. As shown in FIG. 1, the respective connectors 13A and 13B of the card slot 10 are connected to a card interface unit provided in the digital equipment 200. The card interface unit transmits/receives various kinds of input/output signals to/from the card 100 attached in the card slot 10 through the card terminals and the respective connectors 13A and 13B.

Specifically, as shown in FIG. 7A, the card 100 has a plurality of card terminals 110 mounted on one plane thereof by printed wirings. FIG. 7B shows the other plane of the card 100.

Specifically, as shown in FIG. 8A, the digital equipment 200 is a PDA including a display portion 220 or an operation key 230 on one surface side of a main body. FIG. 8B shows the other surface side of the PDA main body. On the other surface side are incorporated the card slot 10 of this embodiment together with a battery cover 240.

The PDA 200 comes into contact with the card 100 attached in the card slot 10, and it is used to save various kinds of data if the card 100 is, e.g., a memory card. Furthermore, if the card 100 is, e.g., a wireless communication card, the PDA 200 performs wireless data communication with the outside through the card 100.

(Structure of Insulator 30)

When the card 100 is ejected from the card slot 10, the respective connectors 13A and 13B may be possibly come into contact with each other and be electrically short-circuited as shown in FIG. 2.

Thus, as shown in FIG. 3, the card slot 10 of this embodiment has an insulator 30 used to prevent a short circuit between the respective connectors 13A and 13B. As shown in FIG. 9, the insulator 30 is a plate-like member consisting of an electrically insulating material, and configured to slide (move) in the same direction as the attachment/detachment direction of the card 100.

It is to be noted that FIG. 9 is a view showing a partial external appearance of the card slot 10 depicted in FIG. 3. That is, a plane portion on which the connector 13B is provided (e.g., upper surface side) is eliminated in FIG. 9.

As shown in FIG. 3, one end portion of the insulator 30 is arranged in the card slot 10, and the other end portion of the same is pressed in the inner direction of the slot 10 by a spring member 31 arranged outside the card slot 10. That is, when the card 100 is inserted into the card slot 10, the insulator 30 comes into contact with the end portion of the card 100 and is pushed to the outer side of the card slot 10.

When the card 100 is completely attached in the card slot 10, the end portion of the insulator 30 is pushed out from the internal space 12 of the slot 10 (see FIG. 4). This is the state that the card 100 enters between the respective connectors 13A and 13B and the card terminals 110 are in contact with the connector 13A.

Here, when the card 100 is attached in the reverse insertion state in such a manner that the surface of the card 100 having the card terminals 110 mounted thereon is set relatively upward, the card 100 enters between the respective connectors 13A and 13B, and the card terminals 110 and the reversal connectors 13B come into contact with each other (see FIG. 5).

On the other hand, when the card 100 is ejected from the card slot 10, the insulator 30 is no longer pressed by the card 100, and it slides (moves) to the inner side of the card slot 10 by the impetus of the spring member 31. When the card 100 is completely ejected from the inside of the card slot 10, the insulator 30 enters between the respective connectors 13A and 13B (see FIG. 3). Therefore, the insulator 30 is placed between the respective connectors 13A and 13B in accordance with ejection of the card 100 to prevent a short circuit which occurs when the respective connectors 13A and 13B come into contact with each other.

In short, if the structure of the card slot 10 according to the first embodiment is adopted, when the card 100 is not attached in the slot 10, the insulator 30 enters between the respective slot connectors 13A and 13B inside the slot, thereby preventing a short circuit which occurs when the respective connectors 13A and 13B come into contact with each other. Therefore, since a short circuit between the respective connectors 13A and 13B can be prevented, it is possible to avoid the problem that a malfunction occurs in the circuit operation of the card interface unit of the digital equipment 200.

Moreover, when the card 100 is completely attached in the slot 10, the insulator 30 is pushed to the outer side of the card 100. Therefore, the card 100 enters between the respective connectors 13A and 13B, and the card terminals 110 and the slot connectors 13A are brought into contact and connected with each other.

As a result, the card 100 is connected with the card interface unit of the digital equipment 200. On the other hand, when the card 100 is attached in the slot 10 in the reverse insertion manner, the card terminals 110 come into contact with the slot connectors 13B, and the card 100 is connected with the card interface unit of the digital equipment 200.

### SECOND EMBODIMENT

FIGS. 4 and 5 are views showing a structure of a card slot 10 according to a second embodiment of the present invention.

This embodiment relates to a structure in which a movement mechanism (slide mechanism) of the insulator 30 is engaged with an eject mechanism. The eject mechanism has rod-shaped operation member 40 consisting of a metal or an insulating material and a rotation mechanism 41 which engages with both the operation member 40 and the insulator 30.

The operation member 40 is configured to slide (move) in the same direction as the attachment/detachment direction of the card 100, and it slides in the direction opposite to the insulator 30. An operation of the eject mechanism will be described hereinafter with reference to FIG. 4.

When the card 100 is inserted into the card slot 10, the insulator 30 comes into contact with the end portion of the card 100 and is pushed to the outer side of the card slot 10. When the card 100 is completely attached in the card slot 10, the end portion of the insulator 30 is pushed out from the internal space 12 of the slot 10. This is the state that the card 100 enters between the respective slot connectors 13A and 13B and the card terminals 110 are in contact with the slot connectors 13A.

At this time, the end portion of the insulator 30 placed on the outer side of the slot 10 rotates the rotation mechanism 41. The operation member 40 is moved so as to slide in the direction of the insertion opening 11 of the slot 10 by this operation of the rotation mechanism 41. Therefore, the end portion of the operation member 40 protrudes from the slot 10.

On the other hand, in order to take out the card 100 from the slot 10, the operation member 40 is pushed in the inner direction of the slot 10. By this operation, the end portion of the operation member 40 rotates the rotation mechanism 40 in the direction opposite to the former direction. The insulator 30 slides (moves) to the inner side of the card slot 10 by this operation of the rotation mechanism 41.

Therefore, the insulator 30 acts so as to push out the card 100 in the direction of the insertion opening 11 from the inside of the card slot 10. The insulator 30 enters between the respective connectors 13A and 13B (see FIG. 3). Accordingly, the insulator 30 is placed between the respective connectors 13A and 13B, thereby preventing a short circuit from occurring when the respective connectors 13A and 13B come into contact with each other. In this state, the card 100 is distanced from the respective connectors 13A and 13B and it can be taken out by the user.

FIG. 5 shows the case that the card 100 is attached in the slot 10 in the reverse insertion manner. In this case, the card 100 enters between the respective connectors 13A and 13B, and the card terminals 110 are in contact with the slot connector 13B for the reverse insertion. In this case, like FIG. 4, by operating (pushing out) the operation member 40, the card 100 can be likewise ejected from the card slot 10 by interlocking of the rotation mechanism 41 and the insulator 30.

In short, if the structure of the card slot 10 according to the second embodiment is adopted, by operating (pushing out) the operation member 40 of the eject mechanism when the card 100 is being attached in the slot 10, the card 100 can be ejected from the card slot 10 by interlocking of the rotation mechanism 41 and the insulator 30. In this case, the insulator 30 enters between the respective slot connectors 13A and 13B in the slot 10, and a short circuit can be prevented from occurring due to a contact between the respective connectors 13A and 13B.

Therefore, if the structure of this embodiment is adopted, the insulator 30 functions as a constituent element of the eject mechanism for the card 100 and also as an element which prevents a short-circuited state between the respective connectors 13A and 13B in the slot 10.

As described above, according to this embodiment, when the card module is not attached in the card slot having the reversible connectors, it is possible to avoid a state that the respective slot connectors are short-circuited. Since applying the card slot having such a structure to a digital equipment can prevent a short circuit from occurring due to a contact between the respective connectors in the card slot, it is possible to avoid occurrence of a malfunction in the card interface unit or the like in the digital equipment in particular.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A card slot unit including an internal space which detachably accommodates a card module therein, comprising:
first and second slot connectors which are members which come into contact with card terminals mounted on one plane of the card module in the internal space in order to enable an electrical connection, and provided on respective planes of the inside in such a manner that they are arranged so as to be opposed to each other; and
an insulator which is positioned between the first and second slot connectors to prevent the first and second slot connectors from coming into contact with each other when the card module is not attached in the internal space.

2. The card slot unit according to claim 1, wherein the first and second slot connectors electrically connect a card interface unit mounted in a digital equipment with the card terminals by a structure to achieve an electrical connection with the card interface unit.

3. The card slot unit according to claim 1, wherein the card module is a memory card or an IC card.

4. The card slot unit according to claim 1, wherein each of the first and second slot connectors consists of a metallic elastic member.

5. The card slot unit according to claim 1, wherein one of the first and second slot connectors is a reversible connector.

6. The card slot unit according to claim 1, wherein the insulating member is a plate-like member which moves in an attachment/detachment direction of the card module,
the card slot unit further comprising:
a movement mechanism which moves the insulating member to the outer side of the internal space in accordance with an attachment operation of the card module, and moves the insulating member to the inner side of the internal space in accordance with an eject operation of the card module.

7. The card slot unit according to claim 1, further comprising:
an eject mechanism which engages with the insulating member, and ejects the card module by moving the insulating member in the inner direction of the internal space when the card module is being attached.

8. The card slot unit according to claim 7, wherein the eject mechanism includes a rotation mechanism which engages with the insulating member and an operation member which engages with the rotation mechanism, and
the eject mechanism is configured to eject the card module by moving the insulating member in the inner direction of the internal space through the rotation mechanism in accordance with an operation of the operation member when the card module is being attached.

9. The card slot unit according to claim 8, wherein the operation member is a rod type member which moves in the attachment/detachment direction of the card module, and configured to move in a direction opposite to the insulating member with respect to the attachment/detachment direction of the card module.

10. The card slot unit according to claim 1, wherein the card slot unit is mounted in a digital equipment which uses the card module, and constituted of a slot main body including the internal space for accommodating the card module therein.

11. A digital apparatus comprising:
a card slot unit which detachably accommodates a card module therein, has first and second slot connectors which are connected with card terminals of the card module, one of the respective slot connectors being a reversible connector, and includes a mechanism which prevents a short circuit between the respective slot connectors; and
a card interface unit which is electrically connected with the respective slot connectors, and electrically connected with the card module through one of the respective slot connectors.

12. The digital apparatus according to claim 11, wherein the mechanism has an insulating member which is positioned between the first and second slot connectors to prevent the first and second slot connectors from coming into contact with each other when the card module is not attached.

13. The digital apparatus according to claim 11, wherein the mechanism has:
a plate-like insulating member which moves in an attachment/detachment direction of the card module; and
a movement mechanism which moves the insulating member to the outer side of the card slot unit in accordance with an attachment operation of the card module, and moves the insulating member to the inner side of the card slot unit in accordance with an eject operation of the card module.

14. The digital apparatus according to claim 12, further comprising:
an eject mechanism which engages with the insulating member, and ejects the card module by moving the insulating member in the inner direction of the card slot unit when the card module is being attached.

15. The digital apparatus according to claim 14, wherein the eject mechanism includes a rotation mechanism which engages with the insulating member and an operation member which engages with the rotation mechanism, and is configured to eject the card module by moving the insulating member in the inner direction of the card slot unit through the rotation mechanism in accordance with an operation of the operation member when the card module is being attached.
